(19) United States
(12) Patent Application Publication
(10) Pub. No.: US 2017/0294659 A1
(43) Pub. Date: Oct. 12, 2017

(54) RELEASE LINER, METHOD FOR MANUFACTURING THE SAME, AND METHOD FOR MANUFACTURING MEMBRANE ELECTRODE ASSEMBLY BY USING RELEASE LINER

(71) Applicant: HYUNDAI MOTOR COMPANY, Seoul (KR)

(72) Inventors: Yong Min KIM, Seongnam-si (KR); Jin Seong CHOI, Yongin-si (KR); Yoon Hwan CHO, Yongin-si (KR); Dae Yong SON, Seoul (KR); Jae Seung LEE, Yongin-si (KR); Young Taek KIM, Incheon (KR); Su Won SEOL, Yongin-si (KR)

(21) Appl. No.: 15/478,366

(22) Filed: Apr. 4, 2017

(30) Foreign Application Priority Data
Apr. 6, 2016 (KR) 10-2016-0042383

(51) Int. Cl. H01M 4/88; H01M 8/1004; H01M 4/86

(52) U.S. Cl. CPC H01M 4/8814; H01M 4/8605; H01M 4/8857; H01M 4/8896; H01M 8/1004

(57) ABSTRACT

A release liner used for manufacturing a membrane electrode assembly includes one or more first films formed of a material having a releasing property, and a second film bonded to the first films and having a tensile strength higher than a tensile strength of the first film. The first films are formed of polytetrafluoroethylene (PTFE) having a non-bonding property and the releasing property.

### CROSS-REFERENCE TO RELATED APPLICATION

This application claims the benefit of priority to Korean Patent Application No. 10-2016-0042383, filed on Apr. 6, 2016, in the Korean Intellectual Property Office, the entire disclosure of which is incorporated herein by reference.

### TECHNICAL FIELD

The present disclosure relates to a release liner, and more specifically, to a release liner that allows an electrode to firmly contact an electrolyte membrane and allows a membrane electrode assembly to be continuously manufactured easily by a roll press even in a low-temperature/low-pressure condition as well, a method for manufacturing the same, and a method for manufacturing a membrane electrode assembly by using the release liner.

### BACKGROUND

A fuel cell is a power generation system that directly converts chemical reaction energy of hydrogen and oxygen contained in a hydrocarbon material such as hydrogen or methanol, ethanol, or a natural gas into electrical energy. Such fuel cell is classified into a phosphorous fuel cell, a molten carbonate fuel cell, a solid oxide fuel cell, and a polymeric electrolyte or alkali fuel cell. The fuel cell is basically operated by the same principle, but the types of fuels, operation temperatures, catalysts, and electrolytes are different.

A fuel cell stack that substantially generates electricity in fuel cells generally has a structure in which several or dozens of unit cells including a membrane electrode assembly and a separator (or a bipolar plate) are stacked.

The membrane electrode assembly may include an electrolyte membrane, an anode electrode (also called a fuel electrode or an oxidation electrode) and a cathode electrode (also called an air electrode or a reduction electrode), which are attached to opposite surfaces of the electrolyte membrane.

A process of manufacturing a membrane electrode assembly will be described as follows. A membrane electrode assembly is assembled by coating electrodes on surfaces of a release liner and bonding the electrodes to opposite surfaces of the electrolyte membrane by applying heat and pressure.

Meanwhile, more binder in the electrode may be distributed on the surfaces of the release liner when the electrodes are coated on the surfaces of the release liner, and as the binder distributed on the surfaces of the release liner pull the electrodes when the electrodes are bonded to the electrolyte membrane, it may be difficult to manufacture the membrane electrode assembly. Accordingly, if the membrane electrode bonding condition is set to a high temperature and a high pressure to increase the releasing property, the electrodes may be smoothly transferred but performance may be lowered due to the damage to the material.

When the electrodes are transferred, a material having a releasing property and a non-bonding property, such as a PTFE film, may be used as a release liner to improve the releasing property. Because the PTFE film allows the electrode to easily be transferred due to the excellent releasing property, the damage to the material may be reduced and reduction of the performance may be prevented.

In this way, when the PTFE film is used as a release liner, the releasing property may be improved while the electrodes are transferred, but it is difficult to apply the PTFE film to an actual manufacturing process due to the high price of the PTFE film. Further, due to the lower tensile strength of the PTFE film, it is difficult to apply the PTFE film to the continuous manufacturing process for the membrane electrode assembly, and accordingly, the productivity of the membrane electrode assembly deteriorates.

### SUMMARY

The present disclosure provides a release liner that allows an electrode to firmly contact a surface of an electrolyte membrane by improving a releasing property thereof and allows a membrane electrode assembly to be continuously manufactured, by preventing the release liner is fed as well, a method for manufacturing the same, and a method for manufacturing a membrane electrode assembly by using the release liner.

The technical objects of the present disclosure are not limited to the above-mentioned one, and the other unmentioned technical objects will become apparent to those skilled in the art from the following description.

In accordance with an aspect of the present disclosure, there is provided a release liner used for manufacturing a membrane electrode assembly, the release liner including one or more first films formed of a material having a releasing property, and a second film bonded to the first films and having a tensile strength higher than a tensile strength of the first film.

Among the one or more first films two first films may be symmetrically stacked on opposite surfaces of the second film.

The first films may be formed of polytetrafluoroethylene (PTFE) having a non-bonding property and a releasing property.

The first films may be formed of polytetrafluoroethylene (PTFE) having a plurality of fine pores.

The second film may be formed of any one of polyethylene terephthalate (PET), polyethylene naphthalate (PEN), polyimide (PI), and polyoxymethylene (POM).

The second film may be formed of a non-contractible material that does not react with an organic solvent.

The first films and the second film may be bonded to each other by using heat and pressure.

The first films and the second film may be bonded to each other by using an adhesive or glue.

The adhesive or glue may be formed of a material that is not mixed with an organic solvent in electrodes when the electrodes are coated on surfaces of the first films.

The adhesive or glue may be at least one of acryl, epoxy, and silicon.

In accordance with another aspect of the present disclosure, there is provided a method for manufacturing a release liner that is used for manufacturing a membrane electrode assembly, the method including preparing a first film and a second film having a tensile strength higher than a tensile strength of the first film, and bonding the second film to the first film by applying heat and pressure.

The method may further include applying an adhesive or glue between the first film and the second film, before the bonding of the second film after the preparing of the first film and the second film.

In accordance with another aspect of the present disclosure, there is provided a method for manufacturing a membrane electrode assembly, the method including, after preparing a release liner in which a first film having a releasing property and a second film having a tensile strength higher than a tensile strength of the first film, forming an electrode on a surface of the first film of the release liner, continuously feeding the release liner having the electrode to a pair of roll presses, and bonding the electrode of the release liner to an electrolyte membrane between the pair of roll presses.

### BRIEF DESCRIPTION OF THE DRAWINGS

The above and other objects, features and advantages of the present disclosure will be more apparent from the following detailed description taken in conjunction with the accompanying drawings:

FIG. 1 is a sectional view illustrating a release liner according to a first embodiment of the present disclosure;

FIG. 2 is a sectional view illustrating a release liner according to a second embodiment of the present disclosure;

FIG. 3 is a flowchart illustrating a method for manufacturing a release liner according to the present disclosure;

FIG. 4 is a view illustrating a process of manufacturing a release liner according to the first embodiment of FIG. 1;

FIG. 5 is a view illustrating a process of manufacturing a release liner according to the second embodiment of FIG. 2;

FIG. 6 is a sectional view illustrating a release liner according to a third embodiment of the present disclosure;

FIG. 7 is a sectional view illustrating a release liner according to a fourth embodiment of the present disclosure;

FIG. 8 is a view illustrating a process of manufacturing a release liner according to the third embodiment of FIG. 6;

FIG. 9 is a view illustrating a process of manufacturing a release liner according to the fourth embodiment of FIG. 7;

FIG. 10 is a graph depicting a performance evaluation result of a membrane electrode assembly manufactured by using a release liner according to the present disclosure;

FIG. 11 is a view illustrating a process of coating an electrode on a release liner according to the present disclosure;

FIG. 12 is a view illustrating an example of an apparatus for manufacturing a membrane electrode assembly by using a release liner according to the present disclosure; and

FIG. 13 is a flowchart illustrating a method for manufacturing a membrane electrode assembly by using a release liner according to the present disclosure.

### DETAILED DESCRIPTION

Hereinafter, exemplary embodiments of the present disclosure will be described in detail with reference to the accompanying drawings. For reference, the sizes of the components and the thickness of the lines of the drawings may be rather exaggerated for convenience of understanding. Further, the terms used in the description of the present disclosure may be different according to the users, the intentions of the operators, or the customs in consideration of the functions in the present disclosure. Therefore, definition of the terms should be made according to the overall disclosure set forth herein.

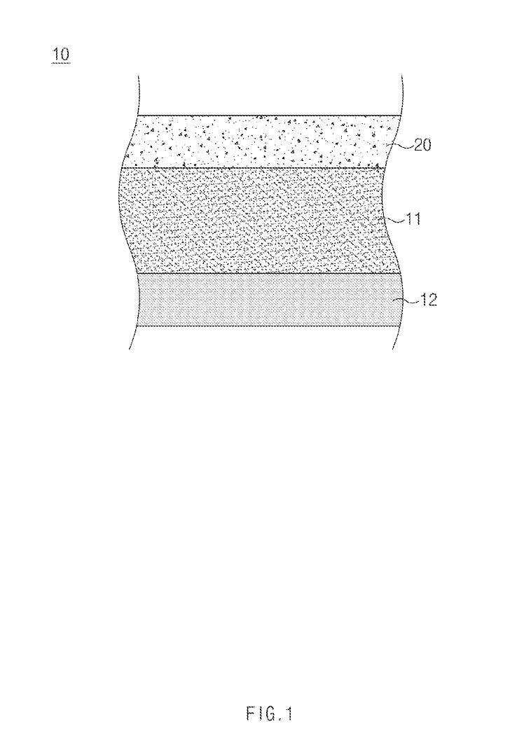

Referring to FIG. 1, a release liner 10 according to various embodiments of the present disclosure may include a first film 11 in which an electrode 20 is coated on one surface thereof, and a second film 12 in which the first film 11 is bonded to one surface thereof.

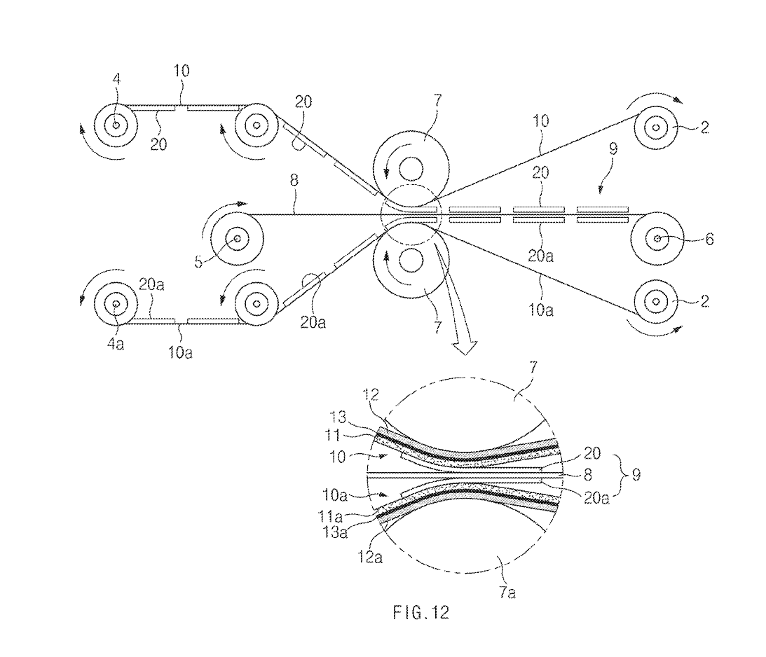

According to various embodiments of the present disclosure, the first film 11 may be formed of polytetrafluoroethylene (PTTE) having a non-bonding property and a releasing property, and accordingly, as illustrated in FIG. 12, the electrode 20 may be easily released from the first film 11 when the electrode 20 coated on a surface of the first film 11 is transferred and bonded to an electrolyte membrane 8, and accordingly, the electrode 20 may be firmly bonded to the electrolyte membrane 8. The electrode 20 may have a plurality of fine pores.

According to another embodiment, the first film 11 may be formed of a ventilating PTFE material having a plurality of fine pores, such as e-PTEE. In this way, when the first film 11 is formed of the ventilating PTFE material, a roughness of a surface of the electrode 20 coated on the surface of the first film 11 may be increased by the pores of the first film 11 and a plurality of fine pores may be formed as well. In this way, as the surface roughness of the electrode 20 is increased, moisture or foreign substances may be effectively prevented from being attached to the surface of the electrode 20.

The above-mentioned first film 11 may have a thickness of 3 μm to 500 μm.

The second film 12 may be bonded to one surface of the first film 11 by using heat and pressure, and in particular, the second film 12 may be formed of a material having a tensile strength higher than a tensile strength of the first film 11.

According to an embodiment, the second film 12 may be formed of any one of polyethylene terephthalate (PET), polyethylene naphthalate (PEN), polyimide (PI), and polyoxymethylene (POM).

Further, it is preferable that the second film 12 be formed of a material that is not thermally contracted while not reacting with an organic solvent in the electrode.

The above-mentioned second film 12 may have a thickness of 25 μm to 200 μm.

According to the release liner 10 of the present disclosure, a bonding property of the electrode may be remarkably improved as the electrode coated on the surface of the first film 11 having an excellent releasing property may be easily released towards the electrolyte membrane 8, elongation of the first film 11 due to a tensile force may be minimized while the release liner 10 is fed during continuous manufacturing of the membrane electrode assembly 9 using a roll press, due to a structure in which the second film 12 having a tensile strength higher than the tensile strength of the first film 11 is combined with the first film 11, and the electrode may be stably coated on the surface of the first film 11 and may be firmly bonded to the surface of the electrolyte membrane 8.

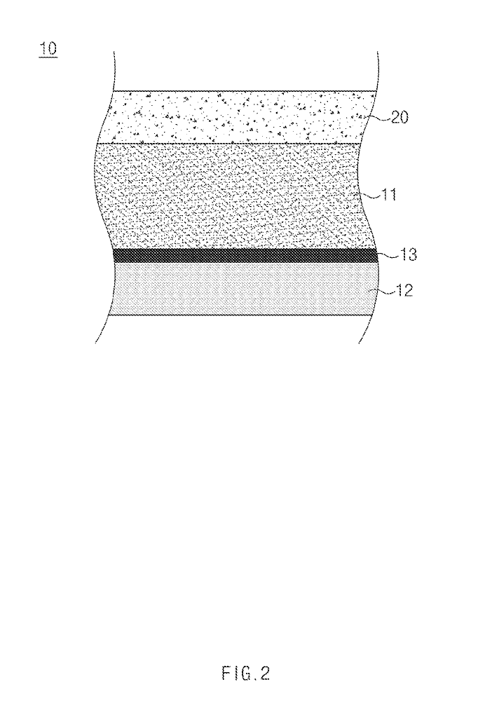

According to the embodiment of FIG. 2, the first film 11 and the second film 12 may be bonded to each other by using an adhesive or glue 13, and accordingly, the first film 11 and the second film 12 may be bonded to each other in a firmer structure.

It is preferable that the adhesive or glue 13 be formed of a material that is not mixed with an organic solvent in the electrode when the electrode is coated on the surface of the first film 11.

The adhesive or glue 13 may be formed of at least one of acryl, epoxy, and silicon.

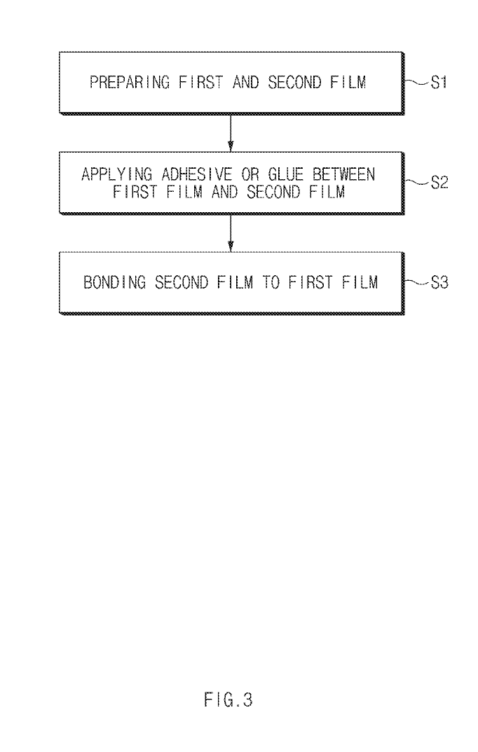

FIG. 3 illustrates a method for manufacturing a release liner 10 for a membrane electrode assembly 9 according to various embodiments of the present disclosure.

As illustrated in FIG. 3, the method for manufacturing a release liner 10 for a membrane electrode assembly 9 according to the present disclosure may include an operation S1 of preparing a first film 11 and a second film 12, and an operation S3 of bonding the second film 12 on one surface of the first film 11.

In operation S1, the first film 11 having a non-bonding property and a releasing property, such as polytetrafluoroethylene (PTFE), and the second film 12 having a tensile strength higher than the tensile strength of the first film 11 may be prepared.

According to an embodiment, in operation S3, the second film 12 may be bonded to the surface of the first film 11 by applying heat and pressure to the second film 12.

According to another embodiment, an operation of applying an adhesive or glue 13 between the surface of the first film 11 and a surface of the second film 12 may be further provided between operation S1 and operation S2, and due to the applied adhesive or glue 13, the first film 11 and the second film 12 may be firmly bonded to each other by applying heat and pressure.

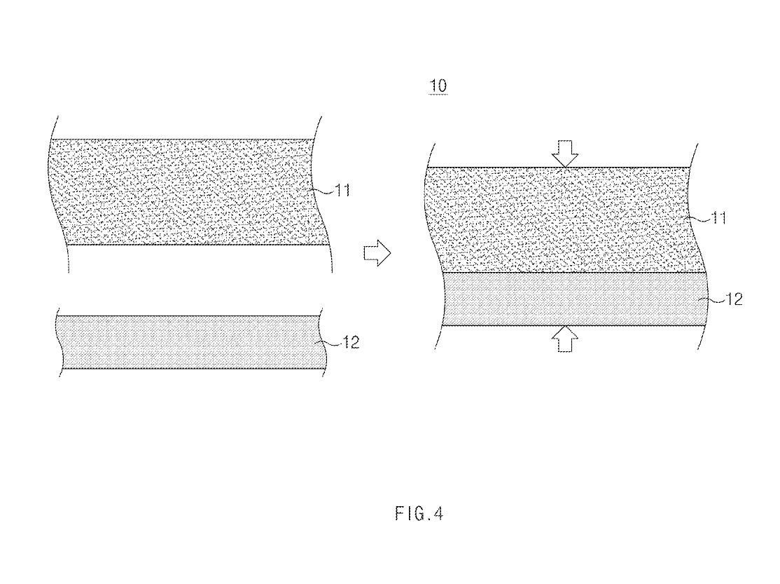

FIG. 4 is a view illustrating a process of manufacturing a release liner 10 according to the embodiment of FIG. 1, and illustrates a process of, after preparing the first film 11 and the second film 12, bonding the first film 11 and the second film 12 by applying heat and pressure after overlapping the first film 11 and the second film 12.

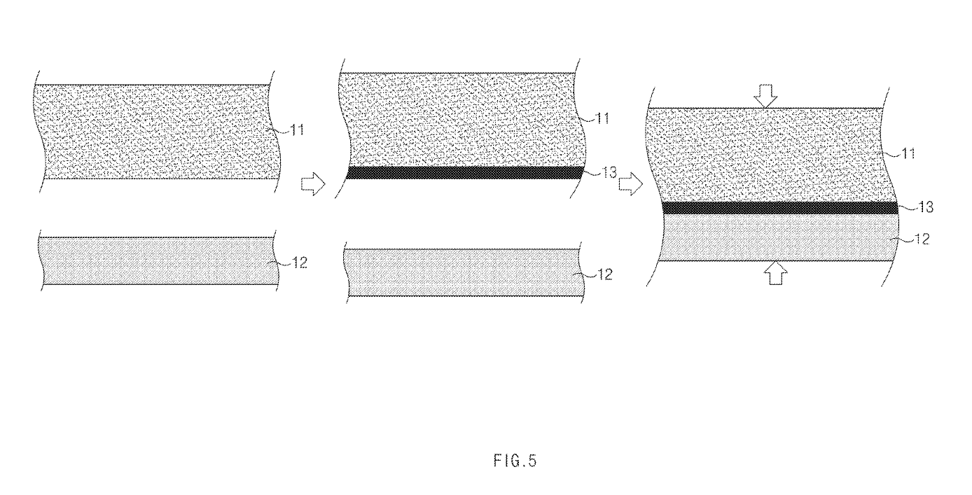

FIG. 5 is a view illustrating a process of manufacturing a release liner 10 according to the embodiment of FIG. 2, and illustrates a process of preparing the first film 11 and the second film 12, overlapping the first film 11 and the second film 12 while the adhesive or glue 13 is applied to the surface of the first film 11 or the surface of the second film 12, and bonding the first film 11 and the second film 12 to opposite surfaces of the adhesive or glue at the same time by applying heat and pressure.

Meanwhile, because the release liner 10 may be curled to one side so that the flatness of the release liner 10 may not be constantly maintained due to the structure in which the first film 11 and the second film 12 having different properties are bonded to each other, the productivity or yield rate of the membrane electrode assembly 9 may be lowered.

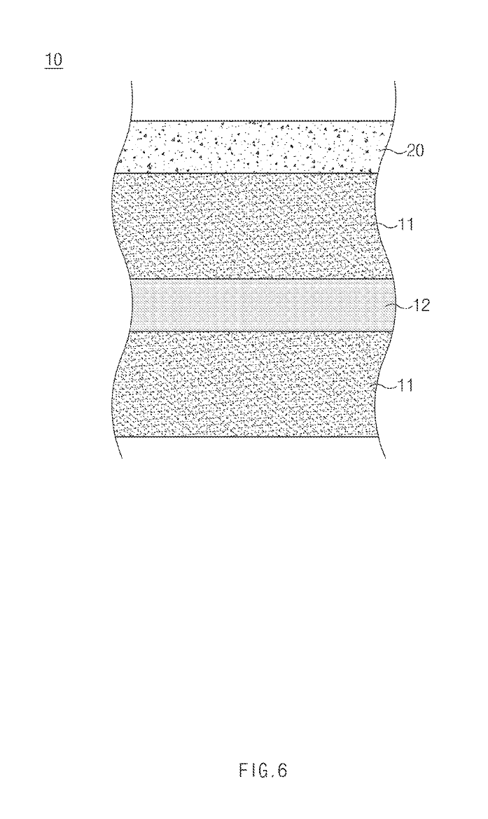

In this regard, the release liner 10 according to the embodiment of FIG. 6 may include two first films 11 that are symmetrically stacked on opposite sides of the second film 12 to be bonded to the second film 12. In this way, because the release liner 10 may be effectively prevented from being curled to one side as the first films 11 are symmetrically disposed on the opposite surfaces of the second film 12, the flatness of the release liner 10 may be stably maintained when the manufacturing process proceeds.

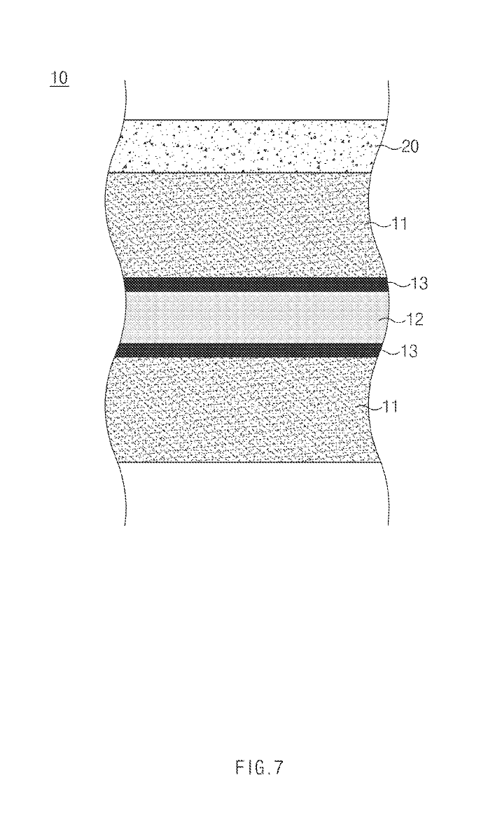

According to the embodiment of FIG. 7, the two first films 11 may be bonded to opposite surfaces of the second film 12 by using an adhesive or a glue 13, and accordingly, the two first films 11 may be firmly bonded to the opposite surfaces of the second film 12.

It is preferable that the adhesive or the glue 13 be formed of a material that is not mixed with an organic solvent in the electrode when the electrodes are coated on the surfaces of the first films 11.

The adhesive or the glue 13 may be formed of at least one of acryl, epoxy, and silicon.

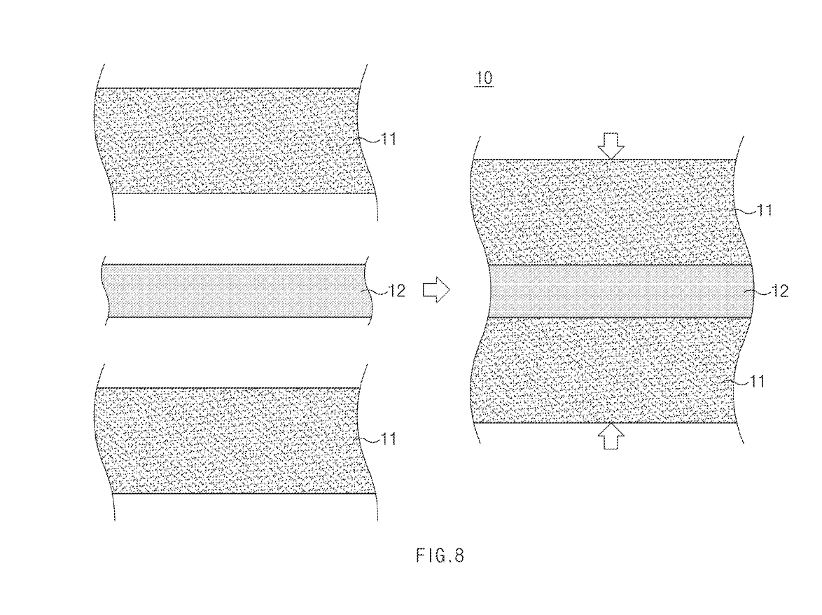

FIG. 8 is a view illustrating a process of manufacturing a release liner 10 according to the embodiment of FIG. 6, and illustrates a process of, after preparing the two first films 11 and the second film 12, symmetrically disposing the two first films 11 on the opposite surfaces of the second film 12, and bonding the first films 11 to the opposite surfaces of the second film 12 by applying heat and pressure.

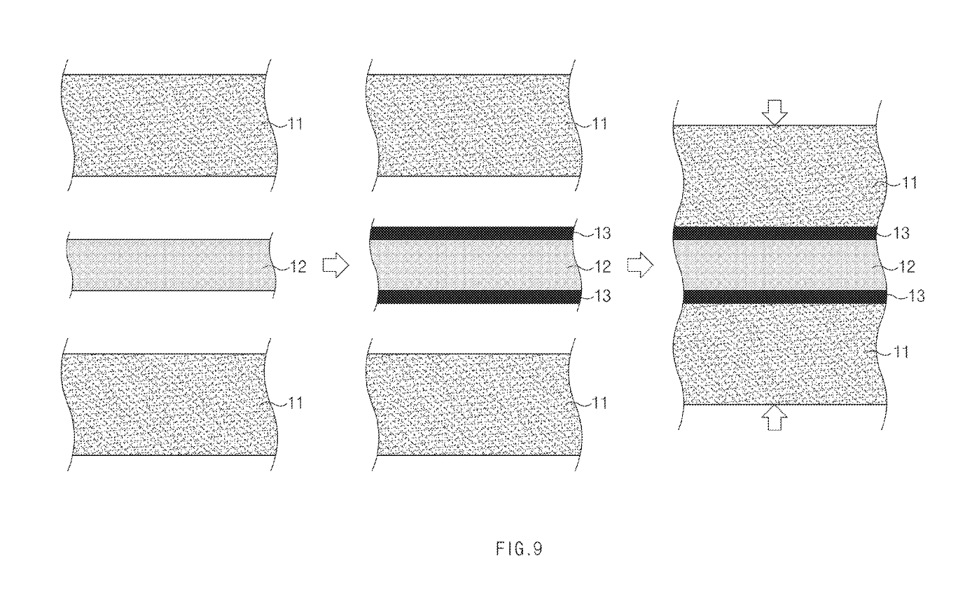

FIG. 9 is a view illustrating a process of manufacturing a release liner 10 according to the embodiment of FIG. 7, and illustrates a process of preparing the two first film 11 and the second film 12, overlapping the first films 11 and the second film 12 while the adhesive or glue 13 is applied to the surfaces of the first films 11 or the opposite surfaces of the second film 12, and bonding the first films 11 and the second film 12 to opposite surfaces of the adhesive or glue at the same time by applying heat and pressure.

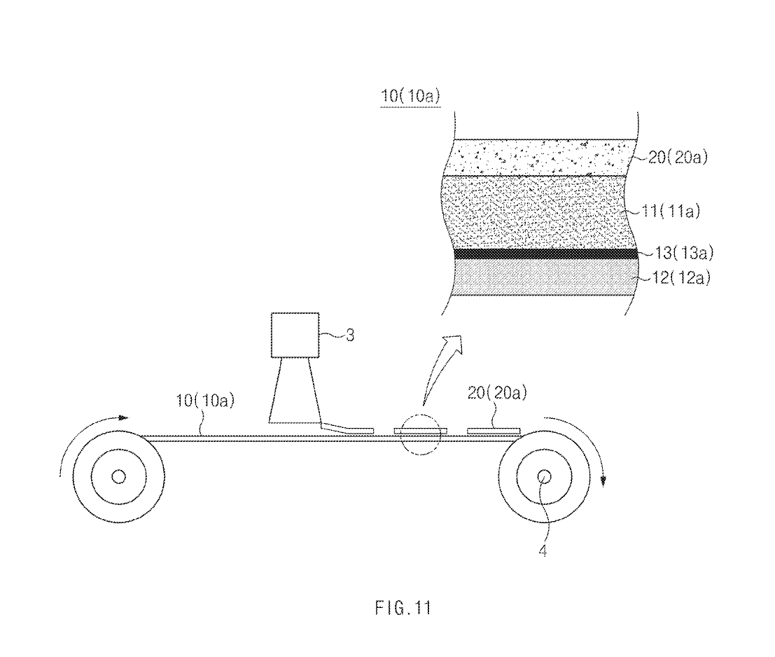

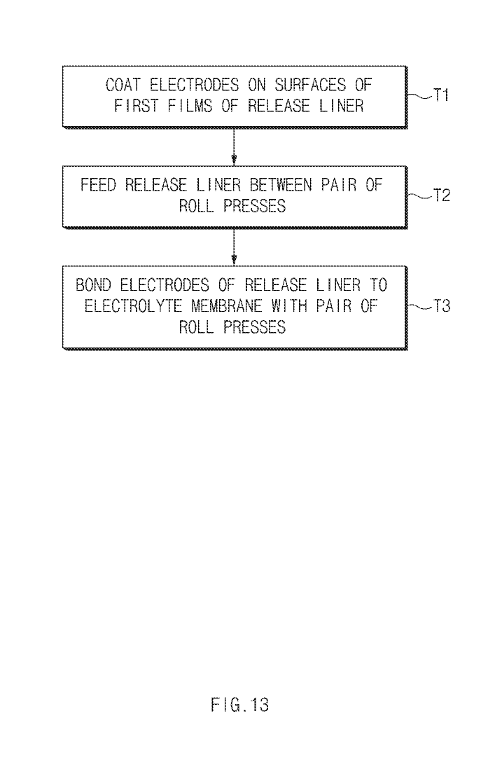

FIGS. 11 to 13 are views illustrating a method for manufacturing a membrane electrode assembly 9 by using the above-mentioned release liner 10.

Referring to FIGS. 11 to 13, according to the method for manufacturing a membrane electrode assembly 9, a membrane electrode assembly 9 may be manufactured by forming electrodes 20 and 20a on the surfaces of the first films 11 of the release liner 10 (T1), feeding the release liner 10 having the electrodes 20 and 20a between a pair of roll presses 7 and 7a (T2), and bonding the electrodes 10 and 10a of the release liner 10 to an electrolyte membrane 8 with the pair of roll presses 7 and 7a (T3).

The process T1 of coating the electrodes 20 and 20a will be described in detail with reference to FIG. 11. A plurality of electrodes 20 and 20a may be formed on the surfaces of the first films 11 of the release liner 10 to be spaced apart from each other by a specific gap by intermittently coating the electrodes 20 and 20a on the surfaces of the first films 11 through a coating machine 3.

In this way, the release liners 10 and 10a coated with the electrodes 20 and 20a are wound on a release liner roll 4. In this way, the membrane electrode assembly 9 may be manufactured by using the release liner rolls 4 on which the release liners 10 and 10a coated with the electrodes 20 and 20a are wound.

FIG. 12 illustrates an example of an apparatus for manufacturing a membrane electrode assembly 9 of roll press equipment, and the apparatus for manufacturing a membrane electrode assembly 9 includes an electrolyte membrane roll 5 on which an electrolyte membrane 8 is wound, a membrane electrode assembly roll 6 located on an opposite side of the electrolyte membrane roll 5, a pair of roll presses 7 and 7a disposed between the electrolyte membrane roll 5 and the membrane electrode assembly roll 6, an upper release liner roll 4 disposed on the electrolyte membrane roll 5, and a lower release liner roll 4a disposed under the electrolyte membrane roll 5.

When the electrolyte membrane 8 is unwound from the electrolyte membrane roll 5 and is fed to the pair of roll presses 7 and 7a, the release liners 10 and 10a coated with the electrodes 20 and 20a may be unwound from the upper release liner roll 4 and the lower release liner roll 4a and may be fed to the pair of roll presses 7 and 7a (T2).

The pair of roll presses 7 and 7a may press the opposite surfaces of the electrolyte membrane 8 such that the electrodes 20 and 20a may be released from the first films 11 of the release liners 10 and 10a to be bonded to the opposite surfaces of the electrolyte membrane 8 (T3). Here, the polarities (an anode electrode and a cathode electrode) of the electrode 20 of the release liner 10 unwound from the upper release liner roll 4 and the electrode 20a of the release liner 10a unwound from the lower release liner roll 4a are opposite to each other.

Further, the electrolyte membrane 8, to which the electrodes 20 and 20a are bonded, may be wound on the membrane electrode assembly roll 6, and the release liners 10 and 10a, from which the electrodes 20 and 20a are released, may be wound on a collection roll 2 to be collected and recycled.

In this way, according to the present disclosure, the electrodes 20 and 20a may be easily released from the release liners 10 and 10a due to the first films 11 and 11a having a releasing property of the release liners 10 and 10a, elongation of the first films 11 due to a tensile force may be minimized due to the second films 12 and 12a of the release liners 10 and 10a while the release liners 10 and 10a are fed by the rollers, and accordingly, the electrodes 20 and 20a may be stably coated on the surfaces of the first films 11 and may be filmy bonded to the surface of the electrolyte membrane 8 as well.

In particular, according to the present disclosure, the release liners 10 and 10a may be fed by the roll presses 7 and 7a and the membrane electrode assembly 9 may be continuously manufactured very effectively by using the release liners 10 and 10a to which the first films 11 and 11a and the second films 12 and 12a, and accordingly, the productivity of the membrane electrode assembly 9 may be remarkably improved.

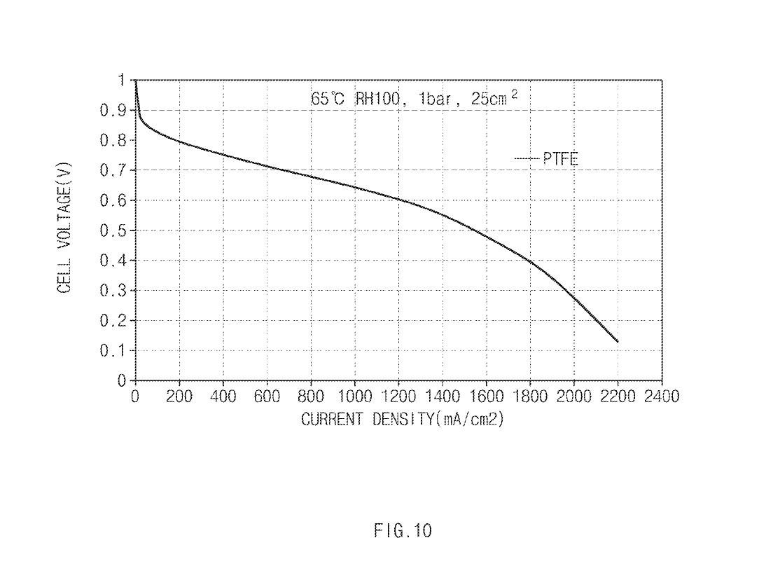

FIG. 10 is a graph depicting a performance evaluation result of a membrane electrode assembly 9 manufactured by using a release liner 10 according to the present disclosure;

FIG. 10 is a graph depicting current densities depending on voltages of the membrane electrode assembly 9 manufactured by bonding the electrode released form the release liner 10 to the electrolyte membrane 8 when heat of 110° C. and a pressure of 70 kgf are applied to the roll press while the roll press is rotated at a rotational speed of 0.2 m/min. FIG. 10 shows that the membrane electrode assembly 9 manufactured according to the present disclosure has a performance of 1200 mA/cm2 at 0.6 V, which is similar to a membrane electrode assembly 9 manufactured through an existing method.

According to the present disclosure, the electrodes may be firmly bonded to the opposite surfaces of the electrolyte membrane 8 by improving the releasing property and the membrane electrode assembly 9 may be continuously manufactured easily by the roll press equipment by preventing elongation of the release liner 10 when the release liner 10 is fed.

Although the detailed embodiment of the present disclosure has been described until now, the present disclosure is not limited to the embodiment disclosed in the specification and the accompanying drawings, and the present disclosure may be variously modified by those skilled in the art without departing from the technical spirit of the present disclosure.

What is claimed is:

1. A release liner used for manufacturing a membrane electrode assembly, the release liner comprising:
one or more first films formed of a material having a releasing property; and
a second film bonded to the first films and having a tensile strength higher than a tensile strength of the first films.

2. The release liner of claim 1, wherein the release liner includes two first films, which are symmetrically stacked on opposite surfaces of the second film.

3. The release liner of claim 1, wherein the first films are formed of polytetrafluoroethylene (PTFE) having a non-bonding property and the releasing property.

4. The release liner of claim 1, wherein the first films are formed of polytetrafluoroethylene (PTFE) having a plurality of fine pores.

5. The release liner of claim 1, wherein the second film is formed of any one of polyethylene terephthalate (PET), polyethylene naphthalate (PEN), polyimide (PI), and polyoxymethylene (POM).

6. The release liner of claim 1, wherein the second film is formed of a non-contractible material that does not react with an organic solvent.

7. The release liner of claim 1, wherein the first films and the second film are bonded to each other by using heat and pressure.

8. The release liner of claim 1, wherein the first films and the second film are bonded to each other by using an adhesive or glue.

9. The release liner of claim 8, wherein the adhesive or glue is formed of a material that is not mixed with an organic solvent in electrodes when the electrodes are coated on surfaces of the first films.

10. The release liner of claim 9, wherein the adhesive or glue is at least one of acryl, epoxy, and silicon.

11. A method for manufacturing a release liner that is used for manufacturing a membrane electrode assembly, the method comprising:
preparing a first film and a second film having a tensile strength higher than a tensile strength of the first film; and
bonding the second film to the first film by applying heat and pressure.

12. The method of claim 11, further comprising:
applying an adhesive or glue between the first film and the second film, before the bonding of the second film to the first film and after the preparing of the first film and the second film.

13. A method for manufacturing a membrane electrode assembly, the method comprising:
after preparing a release liner in which a first film having a releasing property and a second film having a tensile strength higher than a tensile strength of the first film, forming an electrode on a surface of the first film of the release liner;
continuously feeding the release liner having the electrode to a pair of roll presses; and
bonding the electrode of the release liner to an electrolyte membrane between the pair of roll presses.
